(19) United States
(12) Patent Application Publication
(10) Pub. No.: US 2011/0075071 A1
(43) Pub. Date: Mar. 31, 2011

(54) METHOD FOR MANUFACTURING A LIGHT GUIDE FOR A BACKLIGHT MODULE IN A LCD MODULE

(75) Inventors: Serge Toussaint, Heerlen (NL); Frans Verweg, Heerlen (NL); Michiel Vanneste, Gent (BE); Jozef Gawron, Tielt (BE); Didier Servaas A. Leclercq, Lovendegem (BE)

(73) Assignees: TPO Displays Corp., Chu-Nan (TW); Vitalo Plastics N.V., Meulebeke (BE)

(21) Appl. No.: 12/567,479

(22) Filed: Sep. 25, 2009

(51) Int. Cl. G02F 1/13357; B29D 11/00

(52) U.S. Cl. 349/65; 264/1.24; 264/1.27

(57) ABSTRACT

A method of manufacturing a light guide for a backlight module in a liquid crystal display module is provided. The method includes the following steps: providing a foil; and pressing the foil at a first temperature above a glass transition temperature of a material of the foil to form a thickness profile of the light guide.

### FIELD OF INVENTION

The present invention relates to a method of manufacturing a light guide for a backlight module in a liquid crystal display. Also, the present invention relates to such a light guide. Moreover, the present invention relates to a liquid crystal display module comprising such a light guide.

### BACKGROUND OF THE INVENTION

Conventional LC (Liquid Crystal) display (LCD) modules include an LCD panel and a backlight, in which a side of the LCD panel is attached to a light-emitting side of the backlight. This backlight includes a light guide plate and a light source, for example one or several LEDs.

Typically, the light guide consists of a plate of a plastic material, which is conventionally produced by injection moulding.

The LCD panel includes a plurality of pixel elements, usually arranged in a matrix formation, wherein each pixel element acts as a light shutter and may be controlled individually to be in a transparent state or an opaque state. By selectively controlling each pixel, a (moving) image may be created. The backlight is arranged for producing light that is allowed to pass through the transparent pixels of the LCD panel and is blocked by the opaque pixels to create an illuminated image on the side of the LCD panel not attached to the backlight.

The light of the light source (one or more LEDs) is coupled into the light guide via special in-coupling structure which will improve the uniformity of the light distribution across the light guide. Also the out-coupling structures need to be custom designed in order to achieve a sufficiently uniform light distribution.

Recently, there is an increasing demand for reduction of the total thickness of the LCD display module, often in combination with larger diagonal light guide surface sizes. Consequently the light guide thickness has also been reduced from about 0.6 mm down to about 0.20 mm.

To avoid additional light in-coupling losses due to a large mismatch between LED height and light guide thickness, the LED thickness needs to be reduced in line with the light guide thickness. For example, in order to achieve a loss-less in coupling of light, the LED thickness of a light guide having a thickness of 0.28 mm should be around 0.3 mm (i.e. the effective light output height of a LED is always a fraction smaller than the LED's actual physical thickness, i.e. in this case smaller than 0.3 mm). However, the luminous intensity of thin LEDs reduces as a function of the LED thickness.

Although the LED thickness reduction trend is still ongoing, this trend lies behind the light guide thickness reduction trend, i.e. the roadmap to come to thinner light guides is (much) more aggressive than the LED thickness reduction roadmap.

In summary, the reduction in light guide thickness will result in a reduced light output out of the light guide, and consequently a reduced module luminance, as a result of the following trends:
Reduced light guide thickness with respect to LED thickness, decreases the LED-light guide in-coupling efficiency;
Reducing the LED height in line with the reduction in light guide thickness will also result in lower light guide luminance because the thinner LEDs (still) have a lower LED luminous intensity.

Moreover, the application of injection moulding to produce a light guide plate is adversely affected by the reduction of the thickness of the light guide. In the injection moulding process, the plastic material is brought in a liquid condition (by using heat) and is injected under pressure into the mould.

Because of the relatively high viscosity of the liquid plastic, the zones through which the plastic has to flow need to have a minimal dimension. If the dimension in a certain zone is too small, the liquid plastic will not be able to fill up that certain zone completely or possibly not at all. Because of this limitation, there is a need for an alternative production process.

### SUMMARY OF THE INVENTION

The present invention relates to a method of manufacturing a light guide which may include the following steps: providing a foil; pressing the foil at a first temperature above a glass transition temperature of a material of the foil to form a thickness profile of the light guide into the foil.

Also, the present invention relates to a light guide manufactured from a foil according to a method as described above. Also, the invention relates to a backlight module may include such a light guide. Moreover, the invention relates to a liquid crystal display module comprising such a light guide. Also, the invention relates to an image display system comprising an electronic device. The electronic device comprises such a liquid crystal display module.

The foregoing and other features of the invention will be apparent from the following more particular description of embodiments of the invention.

### BRIEF DESCRIPTION OF THE DRAWINGS

The present invention is illustrated by way of example and not intended to be limited by the figures of the accompanying drawing, in which like notations indicate similar elements.

FIG. 1 schematically shows a cross-sectional view of a LCD display module;

FIG. 2 schematically shows an arrangement of an LED and a light guide;

FIG. 3 shows a flow diagram of a method of manufacturing a light guide in accordance with the present invention;

FIGS. 4a, 4b and 4c schematically show a layout of a light guide after the first formation process;

FIGS. 5a and 5b schematically show a layout of a light guide after the second formation process;

FIGS. 6a, 6b, 6c and 6d schematically show a layout of a light guide after the third formation process;

FIGS. 7a and 7b schematically show a layout of a light guide according to an embodiment.

### DETAILED DESCRIPTION

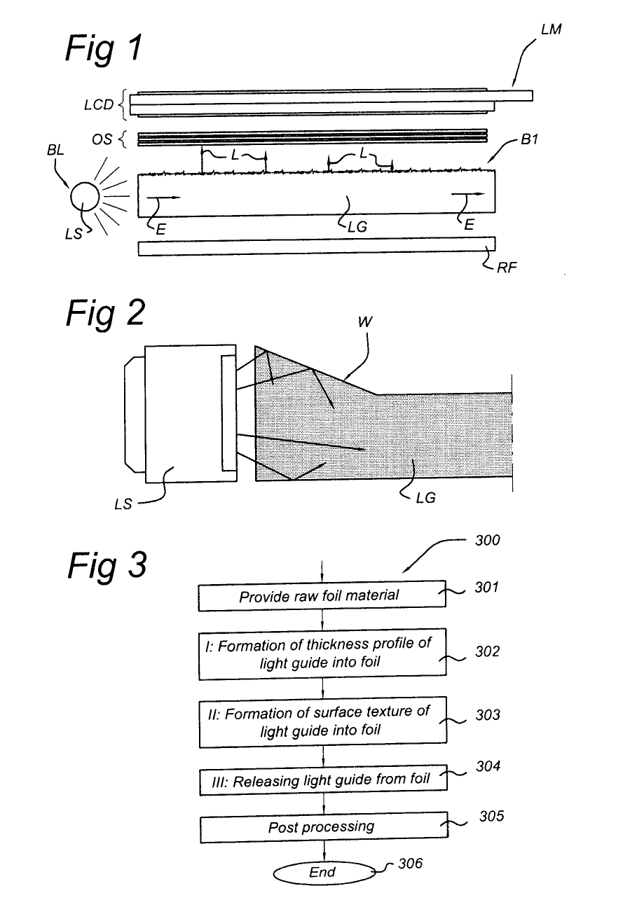

FIG. 1 schematically shows a cross-sectional view of a LC display module LM. The LC display module LM includes an LCD panel with polarizers, a backlight BL which includes an optical (foil) stack OS, a light guide LG and a light source LS. The optical stack OS serves for re-directing and enhancing the light that is emitted from the light guide, and is located between the LCD panel and the light guide LG. At the bottom side of the light guide LG usually a reflector foil is positioned in order to recycle the light that leaves the backside of the light guide LG.

A side of the LCD panel is attached to a light-emitting surface B1 of the backlight BL. The backlight BL includes a light source LS, for example one or several LEDs. The light source LS is coupled to the light guide LG for emitting light (arrows E) into the light guide LG. The light emitting surface B1 of the light guide LG is arranged to couple out the light from the light guide LG in the direction of the optical stack OS and LCD panel. This light emission is indicated by arrows L. On at least one surface of the light guide LG a surface texture is applied which in use is arranged for out coupling of light from the light guide LG through the light emitting surface B1. The surface texture may be applied on either the surface of the light guide LG facing the reflector RF or the surface facing the LCD panel, or both surfaces.

The surface texture is typically designed to achieve a sufficiently uniform light distribution.

FIG. 2 schematically shows an arrangement of the LED light source and the light guide.

The light guide LG features a wedge at the start of the light guide LG in order to reduce the light loss as a result of the mismatch between LED out coupling height and light guide in-coupling height. Due to the above mentioned design rules, i.e., the trend to reduce the thickness of the LCD module LM as a whole and more specifically its components, the reduction of the thickness of the light guide LG leads to a modification of the coupling of the light guide LG and the LED light source LS. The coupling of the LED and the light guide LG is achieved by a wedge shaped portion W of the light guide LG. The wedge shaped portion W provides a transition of a relative large surface for coupling the LED to a smaller cross-section (thinner portion) of the light guide LG as desired by the design rules. In this manner the light in-coupling efficiency is improved in comparison with the situation of a thicker LED directly positioned in front of a thinner light guide without the use of a wedge.

In accordance with the present invention it is recognized that the problems as described above can be solved by manufacturing the light guide LG from a foil material.

It is observed that foil material can be processed to have light guide properties corresponding to those of an injection moulded light guide.

FIG. 3 shows a flow diagram of a method of manufacturing the light guide LG in accordance with the present invention.

The light guide LG from a foil material is produced from a raw material typically a thermoplastic foil raw material with a larger thickness than the desired thickness of the light guide.

Suitable foil material can be selected from a group comprising at least polyamide, polycarbonate, polyester, polymethylmethacrylate (PMMA), Polyethylene terephthalate (PET-G), and cyclic olefin copolymers (e.g., in Topas® COC copolymers).

In a first stage 301 of the method, a foil as raw material (i.e., yet unprocessed) is provided. By using a foil as raw material instead of raw material for injection moulding (i.e. material in the form of pellets), it is advantageously avoided that liquid material has to flow through narrow zones in a mould over larger distances which overcomes the problem of incomplete filling of the mould.

The yet unprocessed foil may be cut or dimensioned to a predetermined size as a preparation for the second stage of the method.

In the second stage 302, the foil as provided in stage 301 is processed in a first formation process to form a desired thickness profile for the light guide into the foil. The thickness profile is applied on the foil by a thermo-forming process. To this end, the foil is inserted in a press between two heated mould portions.

In one, or possible both mould portions, a cavity is created, which has dimensions of one or more zones that need an alternative thickness other than the thickness of the light guide LG. Such one or more zones relate to one or more wedge shaped portions W to be created and possibly other portions of the light guide LG.

Both mould portions are heated above the glass transition temperature and are pressed together under a certain pressure. With this technique, the foil material is plasticized due to the heating above the glass transition temperature, and the plasticized material is deformed by the pressure to obtain a shape corresponding to the internal contours of the mould, and fills up the created cavities to create a foil with the thickness profile for the light guide.

Within the processed foil a shape of a contour or outline of the light guide to be created is defined.

It will be appreciated that the pressure and temperature required in the first formation process are dependent on the actual foil material being used.

As a non-limiting example, it is noted that for the materials listed above a temperature of about 150° C. and a pressure of about 30000 kPa (about 300 atm.) is usable.

The surface finish of both mould portions may be transferred in detail into the foil. In an embodiment, the mould portions have high gloss surfaces to obtain a sufficiently smooth surface of the foil material after the first formation process.

In this manner wedge and/or ramp structures within the foil can be created, that can be required to improve the light in-coupling efficiency as described with reference to FIG. 2.

Alternatively or additionally, one or more steps can be formed on the edges of the foil as supporting structures in the mechanical design of the light guide.

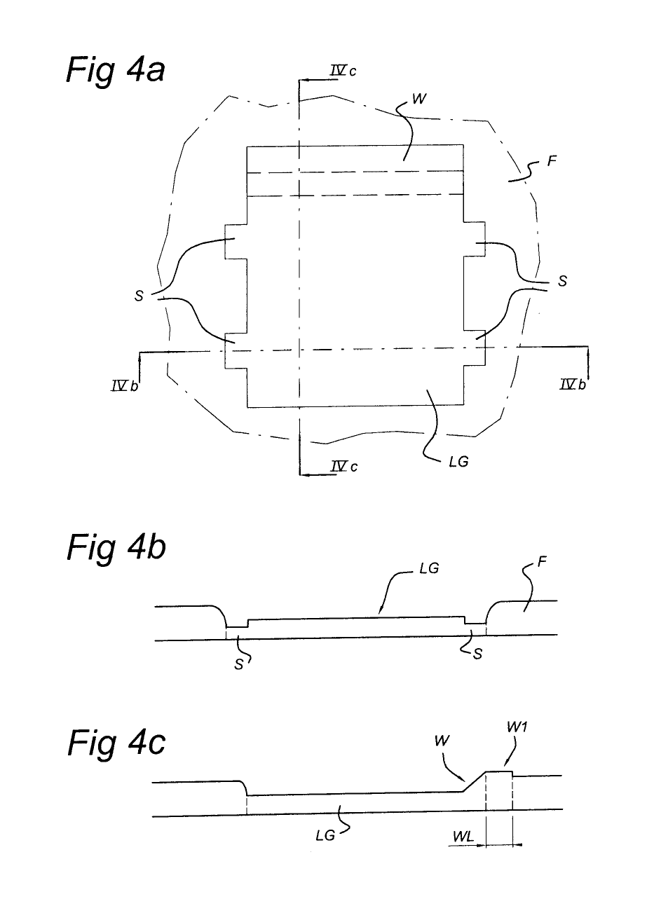

FIGS. 4a, 4b and 4c show schematically a light guide LG after the stage of the first formation process.

FIG. 4a shows the light guide in a plane view. Within the foil F, the outline or contour of the light guide LG is indicated. At one edge of the light guide LG, a wedge shaped portion W is located. In this example, the wedge shaped portion W extends along the full width of the light guide LG.

In the embodiment of FIG. 4a, the wedge shaped portion W is coupled at its thicker part to a substantially flat wedge extension W1, which extends the thicker part of the wedge over a length WL. It will be appreciated that such a flat wedge extension W1 is optional depending on the actual design of the display module.

The two edges adjacent to the one edge that includes the wedge shaped portion W, each include a number of steps S. It will be appreciated that depending on the actual construction of the liquid crystal display module, the number of steps may be different and/or their location may be different. Also, it is conceivable that no steps are present.

FIGS. 4b and 4c show a cross-section along the line IVb-IVb and line IVc-IVc, respectively.

Note that the foil F may be somewhat thicker than the light guide LG itself, to allow the formation of a thickness profile on the light guide LG by plastic flow of the foil material. Due to the plasticity of the foil material the wedge shaped portion W, W1 may be thicker than the foil F. The steps S may be thinner than the remainder of the light guide LG. The pre-product as shown in FIGS. 4a-4c has a surface larger than the end product (i.e. the light guide LG). So from this surface, the end product can be cut out at a later stage.

Referring again to FIG. 3, in a next stage 303, the foil is processed in a second formation process to form a desired surface texture for the light guide into the foil.

The surface texture is applied on the foil by a thermo-forming process. The foil as processed in the first formation process is inserted in a press. A heated metal stamp is pressed on one surface or both surfaces of the product. The metal stamp is heated to an appropriate temperature which is suitable for creating a surface texture.

The heating temperature used during the second formation process may be equal or lower than the heating temperature of the first formation process.

For the materials listed above, a temperature of about 90° C. and a pressure of about 2000 kPa (about 20 atm.) may be used.

On the metal stamp, the negative shape of the desired texture is applied, which shape is transferred into the foil material.

Preferably, a negative structure in the form of cavities is used on the stamp, so protrusions are created on the foil's surface. However, the reversed situation, i.e., protrusions on the stamp for creating dents in the foil's surface is also possible. Next to this, also other textures such as prism-like or v-groove shaped out-coupling structures can be transferred from the stamp into to the plastic light guide material by the thermoforming process at stage 303.

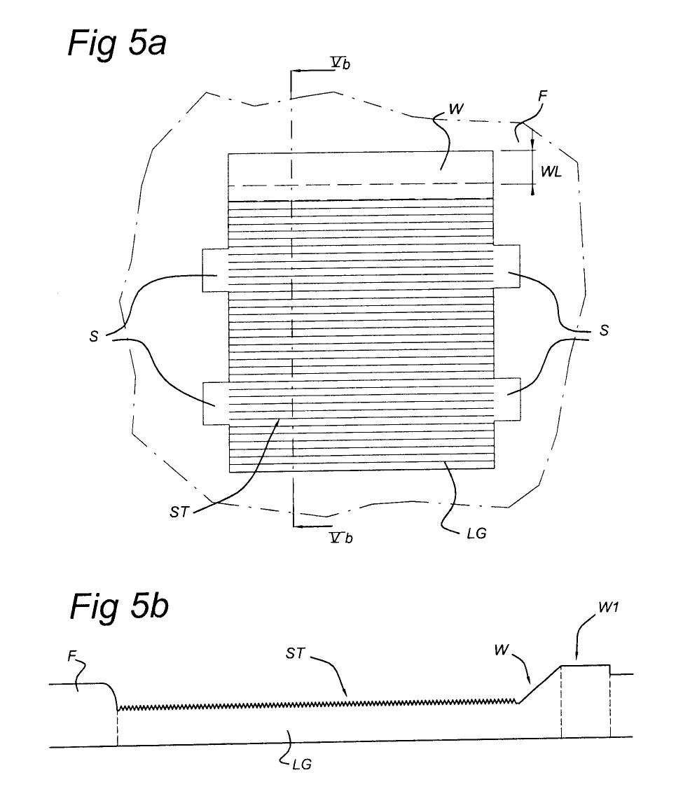

FIGS. 5a and 5b shows schematically a light guide LG after the stage of the second formation process. FIG. 5a shows a plane view of the light guide LG and FIG. 5b shows a cross-section of the light guide LG along the line Vb-Vb.

On the light emitting surface of the light guide LG a surface texture ST is schematically indicated by a hatching.

Referring again to FIG. 3, in a subsequent stage 304, the foil is processed in a third formation process to release the light guide from the processed foil as processed during the first and second formation processes.

The portion of the processed foil for use as light guide is released from the processed foil along the outline of the light guide.

To release the portion for use as light guide, several methods can be used, depending on the actual foil material.

A first embodiment of the third formation process includes mechanical cutting or punching of products out of the foil.

Here the principle is used of a “male-female” cutting system. This means that a male shape presses through a very tightly fitting female shape and presses out the needed shape.

A second embodiment of the third formation process includes cutting by a laser beam from a laser. In the second embodiment, a cutting contour of the foil is followed by the laser beam that locally melts away the foil material and cuts the outline from the remaining foil (also known as skeleton).

The laser may be driven by one of the following systems: a) Galvo system in which the laser beam is guided along the cutting contour by a set of mirrors, b) Nozzle system in which a lens nozzle assembly is used for directing the laser beam along the cutting contour during cutting.

The laser may be of the CO2 type.

A third embodiment of the third formation process includes the application of a water jet as cutting tool. A very narrow beam of water, under high pressure, is guided along the cutting contour and cuts the light guide from the foil material.

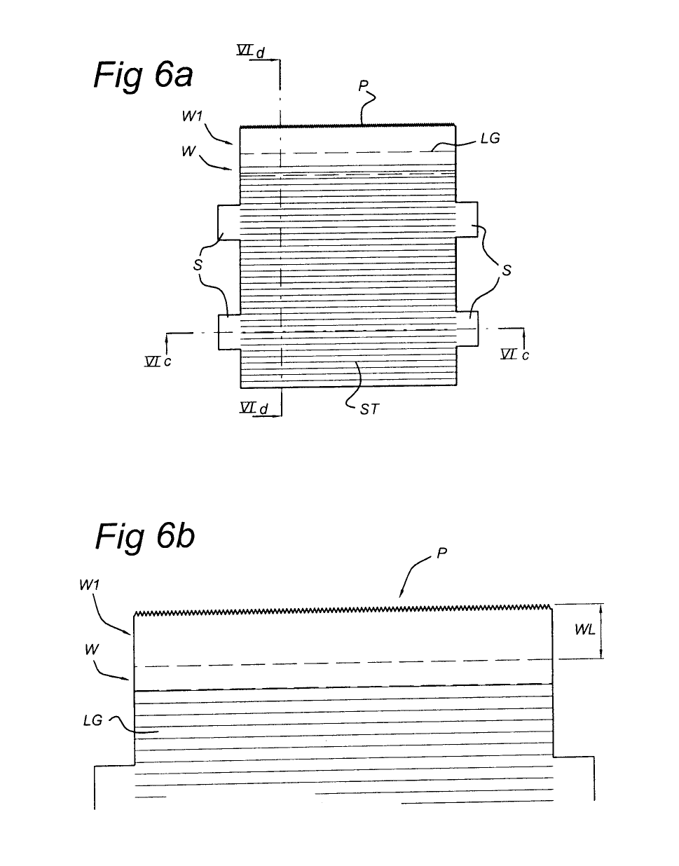

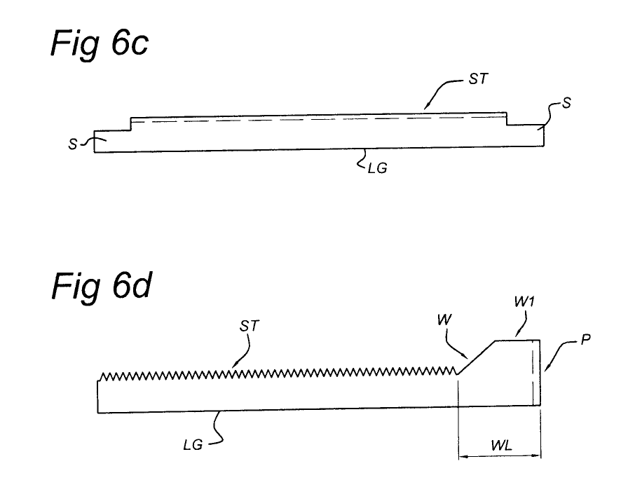

FIGS. 6a, 6b, 6c and 6d show a plane view, a detailed plane view, a first and second cross-sectional view of a light guide LG manufactured in accordance with the present invention. FIGS. 6c and 6d show a cross-section along the line VIc-VIc and line Vld-Vld, respectively.

FIG. 6a shows schematically a plane view of a light guide LG after the stage of the third formation process.

During the stage of the third formation process, on the edge portions that will couple with the light source(s), i.e., the edge of the wedge shaped portion W, W1 that in the liquid crystal display module will face the light emission window of the associated LED, a pattern P may be provided as designed edge geometry, which is further shown in more detail in FIG. 6b. The dotted lines in the light guide LG indicate the transition between the relatively thick wedge shaped portions and the relatively thinner remainder portion of the light guide.

It is noted that the edge (cutting edge) of the outline of the light guide LG may have some specific characteristics. One of these characteristics may be that, on locations where the light guide LG is arranged for coupling with the light source(s), the cutting edge preferably displays a designed edge geometry P (e.g., one edge geometry selected from a group comprising a wave line, a wave pattern, a prismatic structure, semi-cylindrical structures or any other pre-defined geometrical structure).

The designed edge geometry may be necessary in order to improve the incoupling distribution/spreading of light from the light source into the light guide. Consequently, the edge geometry may improve the uniformity of the light distribution emitted from the light guide LG and consequently the front-of-screen performance of the light guide/backlight.

Also, the quality of the cutting edge is very important for the optical performance of the product. Preferably the cutting edge is substantially perpendicular to the light-emitting surface of the light guide LG.

Further, it is required that the cutting edge is substantially burr-free. The cutting edge should be substantially undisturbed by any burr and/or undesired irregularity.

Referring again to FIG. 3, after the stage 304 of the third formation process, the method may include a post-processing stage 305.

Due to the thermal and/or mechanical treatment during the preceding stages 302-304, the light guide LG may have become warped. The post-processing is arranged for substantially flattening the light guide. The post processing provides that the light guide LG is placed between two heated tool plates and that the light guide LG is annealed. Additionally, the tool plates may be brought in close proximity to exert some mechanical pressure on the light guide LG.

If the light guide LG is not warped, then the post-processing can be omitted.

It is noted that the post-processing stage 305 may be applied before the third formation process of stage 304.

It is noted that in an embodiment, the first and second formation processes may be combined in a first combined formation process. In such a combined process the surface of the mould portion that faces the side of the foil that is to be the light-emitting surface of the light guide, includes the negative shape of the desired surface texture.

This first combined formation process is feasible for foil materials that do not show sticking to the surface of the mould portion. A very suitable foil material for this combined process is PMMA. Moreover, when using PMMA, the first combined formation process can be carried out at a temperature of about 150° C. and a pressure of about 30000 kPa.

Additionally, it is noted that in an embodiment the first, second and third formation processes may be combined in a second combined formation process wherein the thickness profile, the surface texture and the outline of the light guide are created simultaneously. In this second single process, there is no cutting process performed. The product is formed in a cavity that has a shape to form the thickness profile and to form the surface texture and additionally has an edge shape to form the designed edge geometry P on the edge of the light guide (e.g., one edge geometry selected from the group comprising a wave line, a wave pattern and a prismatic structure).

A very suitable foil material for this second combined formation process is PMMA. Moreover, when using PMMA, the second combined formation process can be carried out at a temperature of about 150° C. and a pressure of about 30000 kPa.

The present invention provides a method to manufacture a light guide from foil material, which allows the formation of a relatively thin light guide without the prior art difficulty of void formation of injection moulding. Moreover due the use of foil raw material, the light guide area can be as large as required with relatively larger diagonal sizes, only limited by the size of the mould portions. Additionally, it is noted that injection moulded light guides usually exhibit internal stress that eventually may lead to crazing and warpage after the light guide has been ejected from the mould. It is observed that foil based light guides manufactured according to the present invention are substantially free of internal stress when the appropriate (post-) processing is applied.

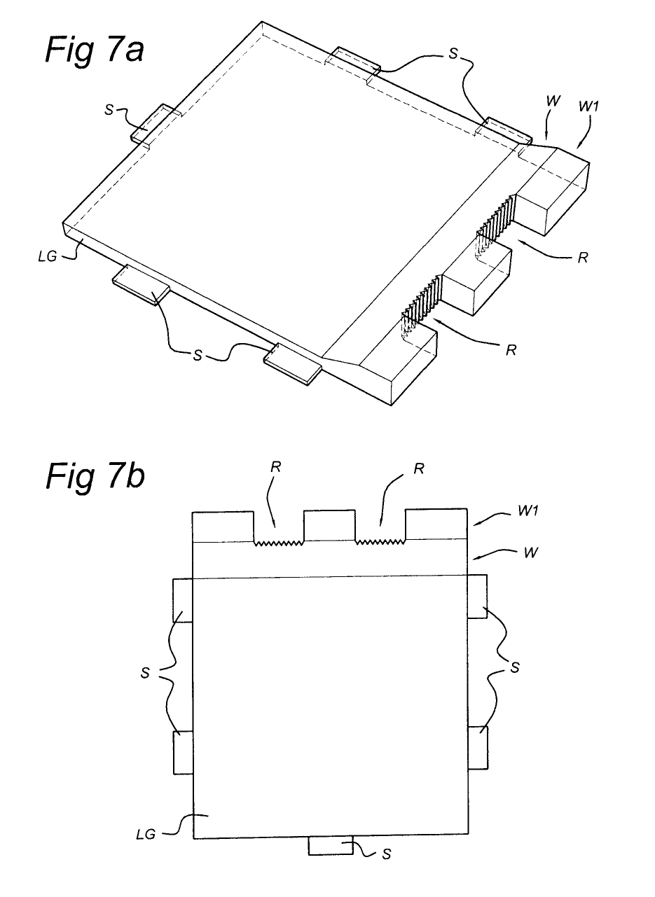

FIGS. 7a and 7b show a further embodiment of a light guide manufactured according to the present invention.

FIG. 7a shows a perspective drawing and FIG. 7b shows a plane view of the light guide.

In the further embodiment the flat wedge extension W1 is provided with one or more recesses R, that locally reduce the length of the wedge extension W1 towards the wedge shape portion W. The one or more recesses R are arranged for accepting at least one of LED within the wedge extension W1. At least the surface of the recesses that face the wedge shaped portion W may include the designed edge geometry P for coupling light from the LED into the light guide LG.

Also, the present invention relates to a backlight module comprising a light guide according to the present invention.

Also the invention relates to an electronic device, which may include a liquid crystal display module equipped with a light guide according to the present invention. The electronic device also includes a power supply (not shown) connected to the liquid crystal display module, to operate the liquid crystal display module. Such an electronic device may be one of a digital camera, a portable DVD displayer, a television, an automotive displayer, a personal digital assistant (PDA), a display monitor, a notebook computer, a tablet computer, or a cellular phone.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A method of manufacturing a light guide for a backlight module in a liquid crystal display module, comprising:
(a) providing a foil; and
(b) pressing the foil at a first temperature above a glass transition temperature of a material of the foil to form a thickness profile of the light guide.

2. The method according to claim 1, wherein the step (b) comprises:
placing the foil between mould portions, the mould portions being heated to the first temperature and being provided with a pattern for shaping the thickness profile of the light guide.

3. The method according to claim 2, wherein the step (b) comprises:
pressing the foil between the heated mould portions to define an outline of the light guide.

4. The method according to claim 1, further comprising:
(c) pressing the foil at a second temperature to form a shape of a surface texture into a surface of the light guide that is intended as a light emitting surface; and the second temperature being equal or lower than the first temperature.

5. The method according to claim 4, wherein the step (c) comprises:
placing the foil provided with the thickness profile of the light guide under a metal stamp, the metal stamp being provided with a surface texture pattern;
heating the foil and/or the metal stamp to the second temperature; and
pressing the metal stamp into the surface of the light guide for transferring the surface texture into the surface of the light guide.

6. The method according to claim 4, further comprising:
(d) releasing the light guide from the foil along the outline of the light guide.

7. The method according to claim 6, wherein the step (d) comprises:
mechanical cutting, punching, cutting by a laser beam and cutting by a water jet.

8. The method according to claim 6, wherein the step (d) comprises:
creating an edge geometry on the cutting edge along the outline of the light guide, the edge geometry being created at least on locations where the light guide is arranged for coupling with a light source.

9. The method according to claim 8, wherein the edge geometry is selected from a group comprising a wave line, a wave pattern, a prismatic structure, a semi-cylindrical structure or any other pre-defined geometrical structure.

10. The method according to claim 6, further comprising:
annealing the foil at a third temperature, the third temperature being lower than the second temperature.

11. The method according to claim 10, further comprising:
exerting a pressure on the surface of the foil.

12. The method according to claim 1, wherein the material of the foil is a thermoplastic material.

13. The method according to claim 1, wherein the material of the foil is one selected from a group comprising polyamide, polycarbonate, polyester, polymethyl methacrylate, Polyethylene terephthalate and cyclic olefin copolymer.

14. The method according to claim 1, further comprising: providing the thickness profile with a thinner flat portion and a wedge shape portion, the wedge shape portion being arranged on a side of the thinner flat portion for coupling with a light source.

15. The method according to claim 14, further comprising:
providing the wedge shaped portion at its thicker part with a wedge extension.

16. The method according to claim 15, further comprising:
providing one or more recesses in the wedge extension, the one or more recesses being arranged for accepting at least one light source.

17. A light guide adopted for a backlight module in a liquid crystal display module, comprising:
a foil, wherein the thickness profile of the light guide is formed with the foil and the foil is pressed at a first temperature above a glass transition temperature of a material of the foil.

18. A light module, comprising:
a light source, and
the light guide according to claim 17.

19. A liquid crystal display module, comprising:
a LCD panel; and
module according to claim 18.

20. An electronic device, comprising:
the liquid crystal display module according to claim 19; and
a power supply, connected to the liquid crystal display module;
wherein the electronic device is a digital camera, a portable DVD displayer, a television, an automotive displayer, a personal digital assistant (PDA), a display monitor, a notebook computer, a tablet computer, or a cellular phone.
